(19) United States
(12) Patent Application Publication
(10) Pub. No.: US 2025/0289511 A1
(43) Pub. Date: Sep. 18, 2025

(54) Drain Valve for a Vehicle Sill

(71) Applicant: Illinois Tool Works Inc., Glenview, IL (US)

(72) Inventor: Elliott Fraser Carter, Southam (GB)

(21) Appl. No.: 19/070,230

(22) Filed: Mar. 4, 2025

(30) Foreign Application Priority Data
Mar. 12, 2024 (GB) 2403553.7
Feb. 10, 2025 (GB) 2501923.3

(51) Int. Cl. B62D 25/24; B62D 25/02

(52) U.S. Cl. CPC B62D 25/24; B62D 25/025

(57) ABSTRACT

The application discloses a drain valve for a vehicle sill. The drain valve includes a valve body, a sill attachment, a gate, moveably attached to the valve body. The gate being moveable between a scaled position and an open position. The gate further includes a buoyancy pocket.

### RELATED APPLICATION

The present application claims the benefit of GB Patent Application Nos. 2403553.7, filed Mar. 12, 2024, and 2501923.3, filed Feb. 10, 2025, each titled “Drain Valve for a Vehicle Sill,” the contents of which are hereby incorporated by reference.

### TECHNICAL FIELD

The disclosure relates to a drain valve for a vehicle sill.

### BACKGROUND

Build up of fluid in sills of vehicles is a known issue and can cause internal corrosion. This can prematurely end the useful service lifetime of a vehicle.

While this issue can be mitigated to an extent through providing an aperture into the sill, such apertures are two-way, letting fluids in, as well as out e.g. When the vehicle passes through deep water.

### SUMMARY OF DISCLOSURE

The present disclosure relates generally to a drain valve, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates an exploded view of a drain valve.

FIG. 2A illustrates a method of installing a drain valve into a sill, including locating the valve adjacent the sill.

FIG. 2B illustrates a method of installing a drain valve into a sill, including attaching the valve to the sill.

FIG. 2C illustrates a method of installing a drain valve into a sill, including completing the sill.

FIG. 3A illustrates a cross section of a drain valve located in a sill, the drain valve in an open position.

FIG. 3B illustrates a cross section of a drain valve located in a sill, the drain valve in a closed position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to the disclosure there is provided a drain valve for a vehicle sill, the drain valve comprising: a valve body, comprising a sill attachment; a gate, moveably attached to the valve body, the gate moveable between a sealed position and an open position, the gate further comprising a buoyancy pocket. The drain valve allows fluid to exit from the cavity of a sill if arranged in the default open position. When a vehicle enters deep water, above the level of the sill, the buoyancy pocket causes the gate to rise with the fluid and places the drain valve in the closed position, preventing ingress of water while the vehicle passes through deep water.

Suitably, the valve body further comprises a seal arranged adjacent the sill attachment to provide a fluid tight connection between the sill attachment and the sill.

Preferably, the seal is a hot melt glue, which can be allow easy attachment of the drain valve to the sill by application of heat.

Appositely, the seal is attached to the valve body so the drain valve is provided in a state that is ready to fit. Optionally, the seal is attached to the valve body by one or more fixations, such as mechanical fixations, to provide a temporary attachment while the hot melt glue is processed.

Suitably, a recess is provided on the sill attachment arranged to receive the seal to allow easy and consistent location of the seal. Optionally, when a seal is located within the recess, the seal is arranged to stand proud of an end of the valve body to ensure a secure and fluid tight connection is made.

Preferably, the sill attachment comprises one or more resilient legs to provide a snap fit to the sill.

Suitably, the resilient legs comprise one or more ramped surfaces arranged to either urge the valve body towards the sill or allow the resilient legs to return to an at rest position, to ensure a tight and secure attachment to the sill.

Appositely, the gate moves from the sealed position to the open position due to the action of gravity upon the gate, to allow the gate to return to a starting position e.g. When a vehicle leaves deep water.

Suitably, the gate is configured to move from the open position to the sealed position due to air trapped in buoyancy pocket.

Preferably, the gate is trapped by the valve body such that the two parts may not unintentionally disassociate.

Appositely, the gate is attached to the body by a sill attachment comprising an eyelet and a stalk.

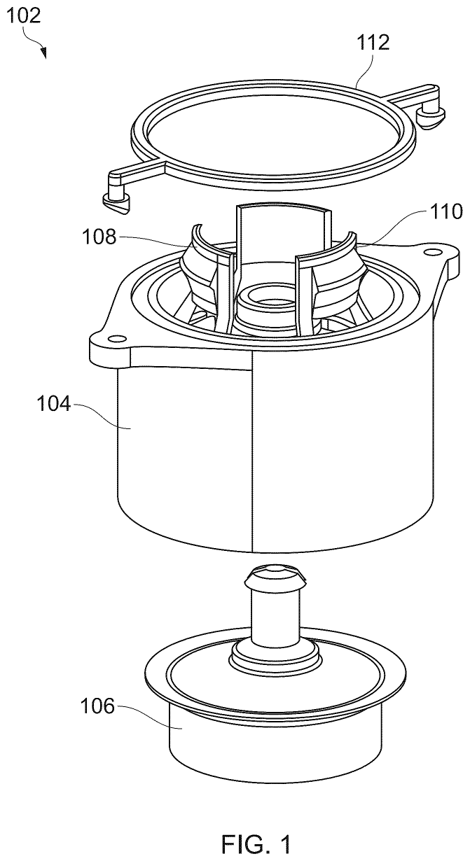

FIG. 1 shows a drain valve 102 in an exploded view. The drain valve 102 has a valve body 104 formed of a surrounding wall forming the through-passage. The through-passage permits the flow of liquid from one end of the drain valve 102 to another end of the drain valve 102.

A gate 106 is provided which is situated within the through-passage when installed in the valve body 104. The gate 106 is capable of occluding the through-passage to prevent the passage of liquid across the valve body 104.

The valve body 104 traps the gate 106 to the valve body 104, but allows the gate 106 to move in a limited fashion relative to the valve body 104 between a position that prevents liquid flow and a position that allows liquid flow through the valve body 104. As per FIG. 1, the trap is an eyelet through which a stalk of the gate 106 passes through. A bulbous end of the stalk prevents the stalk detaching from the eyelet, and the length of the stalk dictates the degree of movement of the gate 106 relative to the valve body 104. The fit between the stalk and the eyelet should be lose to allow free movement of the gate 106 relative to the valve body 104, and for gravity to be sufficient alone to move the gate 106.

The valve body 104 comprises a sill attachment 108 allowing the valve body 104 to be connected and retained in a sill 202 of a vehicle. The sill attachment 108 may take the form of a number (three as shown in FIG. 1) of resilient legs 110 which are capable of snap fitting with a suitable aperture provided in the sill 202. The resilient legs 110 may be provided with ramped surfaces such that as the resilient legs 110 return to their at rest position when inserted through the sill 202, the valve body 104 is urged towards the sill 202.

A seal 112 is provided on the valve body 104 adjacent the sill attachment 108. The seal 112 provides a liquid tight fit between the valve body 104 and the sill 202 when fitted. The seal 112 may be a pre-formed hot melt glue seal 112 configured to melt and adhere to the sill 202 during a normal manufacturing stage of a vehicle (e.g. during heating the body to cure the paint). The seal 112 may be locatable in a recess of the valve body 104, and stand proud of the end of the valve body 104 to ensure good contact of the seal 112 between the sill 202 and the valve body 104. The seal 112 may further be provided with fixations to connect the seal 112 to the valve body 104 ensuring the correct placement and alignment of the seal 112 on the valve body 104 during use. Suitable fixations include embossed pegs which locate into suitable apertures of the valve body 104.

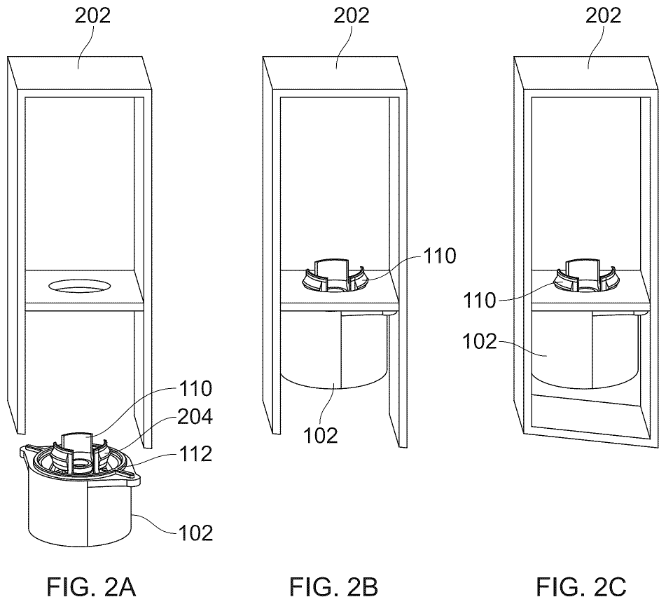

FIG. 2 shows the attachment of the drain valve 102 to a sill 202 of a vehicle. The sill attachment 108 is passed through a suitable aperture of the sill 202 during construction (FIG. 2A). Where the sill attachment 108 is formed of resilient legs 110, the resilient legs 110 snap fit into the aperture and urge the drain valve 102 towards the sill 202 as described above (FIG. 2B), sandwiching the seal 112 between the valve body 104 and the sill 202. Once in place the sill 202 can be completed and the drain valve 102 encased within in an inaccessible position (FIG. 2C).

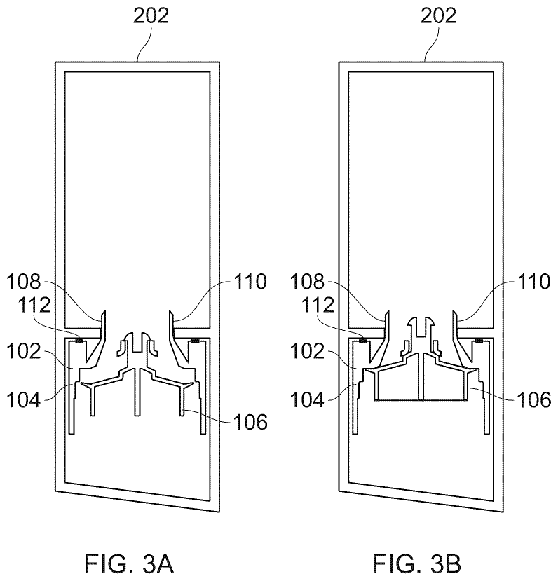

FIG. 3 shows a drain valve 102 in position in a sill 202 with the seal 112 adhering the valve body 104 to the sill 202, providing a liquid tight fit. The drain valve 102 is arranged such that gravity acts on the gate 106 and biases the gate 106 to an open position allowing liquid to flow from the sill 202 through the drain valve 102 to a drain (not shown).

Should the vehicle enter liquid (e.g. when wading, such as crossing a ford), and the liquid depth be greater than the height the sill 202 is placed, and the liquid encounter the drain valve 102, the gate 106 has a buoyancy pocket formed by a blind hole in the gate 106 (such as providing a wall about a perimeter of the gate 106). The buoyancy pocket traps air between the gate 106 and the rising liquid. This provides the gate 106 with buoyancy, such that the gate 106 rises and falls with the liquid. If the rise in liquid is sufficient, the gate 106 is moved from the open position (FIG. 3A) to the closed position (“sealed position” FIG. 3B) and placed in liquid tight fit with the valve body 104. In this way the drain valve 102 allows liquid out of the sill 202 across the drain valve 102, but prevents liquid in the opposite direction, into the sill 202.

The disclosure disclosed herein allows liquid to drain from the upper sill while preventing liquid from entering from below, e.g. during wading. The air trapped in the buoyancy pocket closes the gate 106 to prevent liquid passing.

While the drain valve 102 is described as being biased towards the open position with gravity pulling the gate 106 to the open position, the drain valve 102 may be configured in the opposite, so that gravity pulls the gate 106 to the closed position, and the buoyancy pocket traps air and moved the gate 106 to an open position instead.

The valve body 104 may be formed of any suitable material, such as but not limited to polymers including polyamide.

The gate 106 may be formed of any suitable material to form a liquid tight seal against the valve body 104, including but not limited to soft flexible polymers, silicon, or polyether-ester block copolymer thermoplastic elastomers.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A drain valve for a vehicle sill, the drain valve comprising:
a valve body, comprising a sill attachment;
a gate, moveably attached to the valve body, the gate moveable between a sealed position and an open position, the gate further comprising a buoyancy pocket.

2. The drain valve of claim 1 wherein the valve body further comprises a seal arranged adjacent the sill attachment.

3. The drain valve of claim 2, wherein the seal is a hot melt glue.

4. The drain valve of claim 2, wherein the seal is attached to the valve body, and optionally wherein the seal is attached to the valve body by one or more fixations.

5. The drain valve of claim 2, wherein a recess is provided on the sill attachment arranged to receive the seal, and optionally wherein when a seal is located within the recess, the seal is arranged to stand proud of an end of the valve body.

6. The drain valve of claim 1, wherein the sill attachment comprises one or more resilient legs.

7. The drain valve of claim 6, wherein the resilient legs comprise one or more ramped surfaces arranged to either urge the valve body towards the sill or allow the resilient legs to return to an at rest position.

8. The drain valve of claim 1, wherein the gate moves from the sealed position to the open position due to the action of gravity upon the gate.

9. The drain valve of claim 1, wherein the gate is configured to move from the open position to the sealed position due to air trapped in buoyancy pocket.

10. The drain valve of claim 1, wherein the gate is trapped by the valve body.

11. The drain valve of claim 1, wherein the gate is attached to the body by a sill attachment comprising an eyelet and a stalk.
